(19) United States
(12) Patent Application Publication
(10) Pub. No.: US 2010/0328336 A1
(43) Pub. Date: Dec. 30, 2010

(54) Liquid Crystal Display Wall and Method for Controlling the Same

(76) Inventor: Bingyu SI, Kun Shan (CN)

Correspondence Address: Customer No. 70416;Perkins Coie LLP, Patent - LA, P.O. Box 1208, Seattle, WA, 98111-1208, US

(21) Appl. No.: 12/511,064

(22) Filed: Jul. 28, 2009

(30) Foreign Application Priority Data
Jun. 29, 2009 (CN) 200910151033.5

(51) Int. Cl. G09G 3/36; G09G 5/02

(52) U.S. Cl. 345/589; 345/89; 345/102

(57) ABSTRACT

The present invention relates to liquid crystal display wall and method for controlling the same. An LCD wall according to an embodiment of the invention comprises a display array and a control device, wherein the display array comprises a display panel and a backlight device, and the control device comprises a backlight controller configured to control the backlight device in the display array, and a display controller configured to receive image data and control the display of the image data on the display panel, wherein the display controller is further configured to perform adjustment in grey-scale on the image data corresponding to a backlight brightness of the backlight device. According to the embodiments of the invention, the LCD wall can perform dynamic backlight control, and can output grey-scales with a good uniformity.

### FIELD OF THE INVENTION

The present invention relates to a Liquid Crystal Display wall (LCD wall) and a method for controlling the same.

### BACKGROUND

The LCD wall is a new display equipment that has become popular in recent years, and is advantageous due to environmental-friendliness and energy efficiency. In comparison with a conventional cathode ray tube wall (CRT wall), the LCD wall occupies less space, has a higher resolution and smaller joint gaps, and therefore has been an essential display equipment in such places as exhibitions, public places, video conferences, multi-functional halls, TV stations, entertainment places and TV monitoring places.

A conventional LCD wall consists of a display array and a controller. The display array comprises a display panel having a plurality of LCD display units arranged like a matrix, and a backlight source corresponding to the LCD display units. Image data generated by a signal input device are transmitted to the controller so that display is carried out on the display panel. For the conventional LCD wall, each of the LCD display units in the display panel has to be supplied with a fixed level of backlight irrespective of what image is being displayed on the display panel. As a result, even if for a dim region in a display unit, the corresponding backlight source has to be always kept on, leading to a great waste of energy.

### SUMMARY

In an embodiment of the invention, an LCD wall comprises a display array and a control device, wherein the display array comprises a display panel and a backlight device, the control device comprises a backlight controller configured to control the backlight device in the display array, and a display controller configured to receive image data and control the display of the image data on the display panel, wherein the display controller further performs adjustment in grey-scales on the image data corresponding to a backlight brightness of the backlight device.

In another embodiment of the invention, a method for controlling an LCD wall comprising a display array and a control device, the display array comprising a display panel and a backlight device, the method comprises controlling the backlight device in the display array; and receiving image data and controlling the display of the image data on the display panel, wherein the controlling the display of the image data on the display panel comprises adjusting grey-scales on the image data corresponding to a backlight brightness of the backlight device.

According to the embodiments of the invention, the LCD wall can perform dynamic backlight control, and can output grey-scales with a good uniformity.

### BRIEF DESCRIPTION OF THE DRAWINGS

FIG. 1 is a schematic diagram illustrating an LCD wall according to an embodiment of the invention;

FIG. 2 is a schematic view illustrating a control device for the LCD wall according to the embodiment of the invention;

FIG. 3 is a flow chart illustrating a control process performed by a control device of the LCD wall when displaying a picture according to the embodiment of the invention; and

FIG. 4 is a flow chart illustrating the process performed on local dim units of the LCD wall during the processing step S5 in FIG. 3.

### DETAILED DESCRIPTION OF EMBODIMENTS

Exemplary embodiments will be described in detail in the following with reference to the drawings.

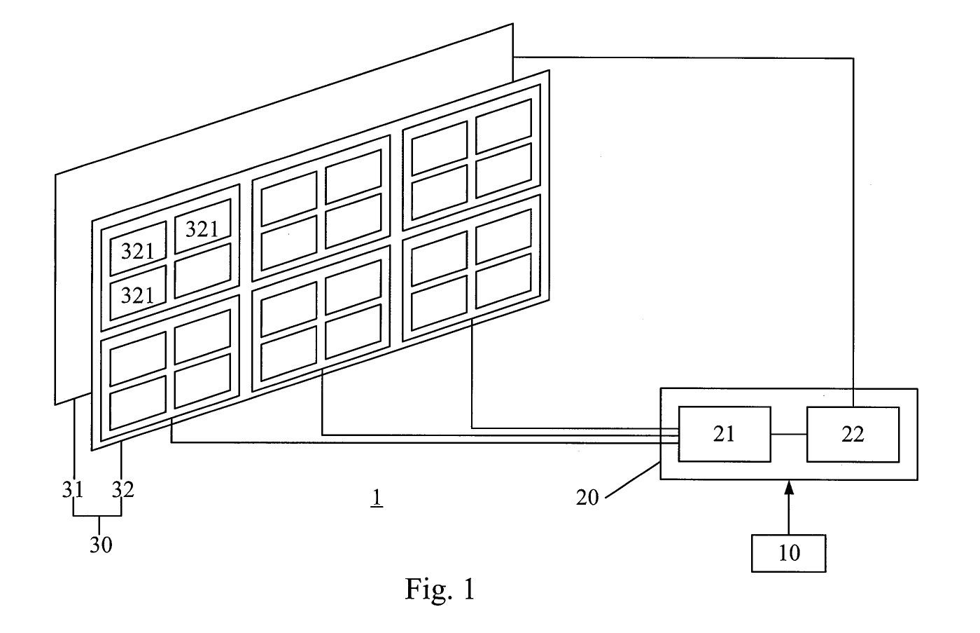

FIG. 1 is a schematic diagram illustrating an LCD wall 1 according to an embodiment of the invention. The LCD wall 1 receives image data from a signal input device 10 and displays corresponding images. As shown in FIG. 1, the LCD wall 1 according to the embodiment comprises a control device 20 and a display array 30.

The signal input device 10 may be a signal source for generating the image data to be displayed by the LCD wall 1, such as a computer, a video playing device, a picture generating device or the like. The image data generated by the signal input device 10 are transmitted to the control device 20 of the LCD wall 1. The image data may be, for example, dynamic videos, or static images (for example text and/or pictures), or a sequence of varying images constituted by one or more static images in a gradual changing manner (for example scrolling, flying, fading in and fading out, etc.). In an embodiment, the signal input device 10 may be integrated into the control device 20. In other words, it is possible to have a single device providing the functions of both the signal input device 10 and the control device 20 so as to, along with the display array 30, form an LCD wall system.

The display array 30 comprises a display panel 31 and a backlight device 32. The display panel 31 comprises a plurality of (that is, two or more) display units (not shown) which may be arranged for example like a matrix or in any other suitable form. Each display unit may be divided into a plurality of display regions, and each display region may comprise a plurality of pixels. The display regions or pixels may also be arranged like a matrix or in any other suitable form. The backlight device 32 may be divided into a plurality of backlight regions 321 which are configured to correspond to the display regions in the display units, for example in a one-to-one correspondence. The backlight device 32 can perform dynamic backlight control, that is, the respective backlight regions therein can be controlled independently, so that the on/off state or magnitude of brightness of the backlights in different backlight regions can be adjusted independently. In the embodiment shown in FIG. 1, the display panel 31 of the display array 30 comprises 6 display units arranged in 2 rows multiplied by 3 columns, and each display unit is divided into 4 display regions; the backlight device 32 comprises 24 backlight regions 321 arranged in 4 rows by 6 columns, and each backlight region corresponds to a display region in the LCD display unit at a corresponding position on the display panel 31. However, these are merely illustrative. The display units included in the display panel 31 of the display array 30, the display regions divided in each display unit, and the backlight regions 321 divided in the backlight device 32 may be selected as appropriate in terms of numbers, arrangements and so on. The backlight device may comprise backlights using Cold Cathode Fluorescent Lamps (CCFLs), Light Emitting Diodes (LEDs) and/or Organic Light Emitting Diodes (OLEDs) as light sources. For convenience, the content displayed on the display panel 30 at the same time (or the data corresponding thereto) will be referred to as a “picture”, and the content displayed on one display unit at the same time (or the data corresponding thereto) will be referred to as an “image frame” or a “frame”.

The control device 20 is coupled between the signal input device 10 and the display array 30, and comprises a backlight controller 21 and a display controller 22. The display controller 22 receives image data outputted from the signal input device 10. The image frames of the respective display units in a picture can be inputted either in parallel or in series, and the image data contained in each image frame are typically inputted in series. The display controller 22 controls the display of the image data on the display panel 31 by, for example, assigning the image data to the corresponding display units, and controlling the timing and sequence representing the image data being inputted into the respective display units. According to the embodiment of the invention, the display controller 22 further adjusts the received image data. Especially in the case of the backlight device 32 performing a dynamic backlight control, the display controller 22 adjusts, corresponding to the backlight brightness of the backlight device 32, the grey-scales of the image data and transmits the adjusted data to the display panel 31. The backlight controller 21 controls the backlight device 32 of the display array 30. The control device 20 may further comprise a central control unit (not shown) performing a cooperation control on the controls respectively performed by the backlight controller 21 and the display controller 22.

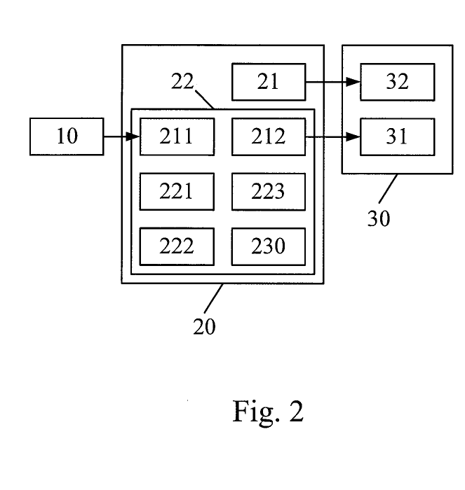

FIG. 2 is a schematic view showing the control device 20 for the LCD wall according to the embodiment of the invention. In the control device 20, as shown in FIG. 2, the display controller 22 comprises a detection unit 211, a Gamma adjusting unit 221, a spatial filter unit 222, a temporal filter unit 223, a uniformity adjusting unit 212 and a memory unit 230, all of which are coupled to each other through a common bus (not shown). In the control device 20, as shown in FIG. 2, the backlight controller 21 is coupled to the backlight device 32 in the display array 30 (in particular, may be coupled to a driving module in the backlight device 32), the detection unit 211 of the display controller 22 is coupled to the signal input device 10, and the uniformity adjusting unit 212 is coupled to each of the display units in the display panel 31 of the display array 30. The control device 20 may be a commonly known signal processing device, such as a Central Processing Unit (CPU), a Digital Signal Processor (DSP), an Application Specific Integrated Circuit (ASIC) or the like. The display controller 22, the backlight controller 21 and the respective units described above may be implemented by separate components (for example chips), or by different portions of a single component, or by a single component through execution of different processes.

The detection unit 211 of the display controller 22 comprises an input/output interface through which the image data from the signal input device 10 are received, and performs a bright/dim determination on the display units based on the image frames that are contained in the image data of a picture and corresponding to the respective display units. If a display unit is determined to be a bright unit based on the frame input to the display unit, then it is determined that normal backlight control should be performed on the display unit, then the backlight controller 21 controls the backlight device 32 in the display array 30 in a normal way. In contrast, if a display unit is determined to be a dim unit based on the input frame, then it is determined that dynamic backlight control should be performed on the display unit. In the case of determination that the dynamic backlight control should be performed, the display controller 22 transmits a dynamic backlight control signal to the backlight controller 21, and the back light controller 21 controls the on/off state and brightness of each of the backlights in the backlight device 32 based on the dynamic backlight control signal. In the case of such a dynamic backlight control, it is not necessary to provide backlight brightness of the same magnitude to the display units.

According to the embodiment of the invention, the control device 20 adjusts each image frame per se in the image data, in addition to controlling the backlight. The adjustment to the image frames are performed by the Gamma adjusting unit 221, the spatial filter unit 222, the temporal filter unit 223 and the uniformity adjusting unit 212, all of which are in the display controller 22.

The Gamma adjusting unit 221 is configured to adjust the Gamma parameters of an image frame. Adjustment to the Gamma parameters of an image frame may comprise, for example, stretch of a grey-scale histogram of the image. In other words, in the image frame, the grey-scale values for the dim pixels are decreased, while those for the bright pixels are substantially not modified. Since the final display result input to human-eyes is synthetically determined by both the backlight and the image, contrast ratio of the picture felt by a user may be improved and display quality may be enhanced through the combination of adjustment to the Gamma parameters of the image frame and adjustment to the backlight device 32 by the backlight controller 21.

The uniformity adjusting unit 212 is configured to perform a spatial smoothing filtering among the respective display units of a picture. The spatial smoothing filtering can improve the picture uniformity among different display units so as to avoid lack of uniformity of the whole picture of the display wall due to excessive grey-scale differences among the image frames displayed by the respective display units.

The spatial filter unit 222 is configured to perform a spatial smoothing filtering on the image in each single display unit. The spatial smoothing filtering of the image of a single display unit can avoid grey-scale non-uniformity among the respective display regions within the display unit.

The temporal filter unit 223 is configured to perform a temporal smoothing filtering on the images sequentially displayed in the display units, so as to eliminate flicker induced by excessive difference of the pixel values of successive image frames in a sequence of images of a single display unit.

The memory unit 230 is configured to store the data in association with the image frames that have been displayed, for comparison with later image frames so as to perform the temporal smoothing filtering.

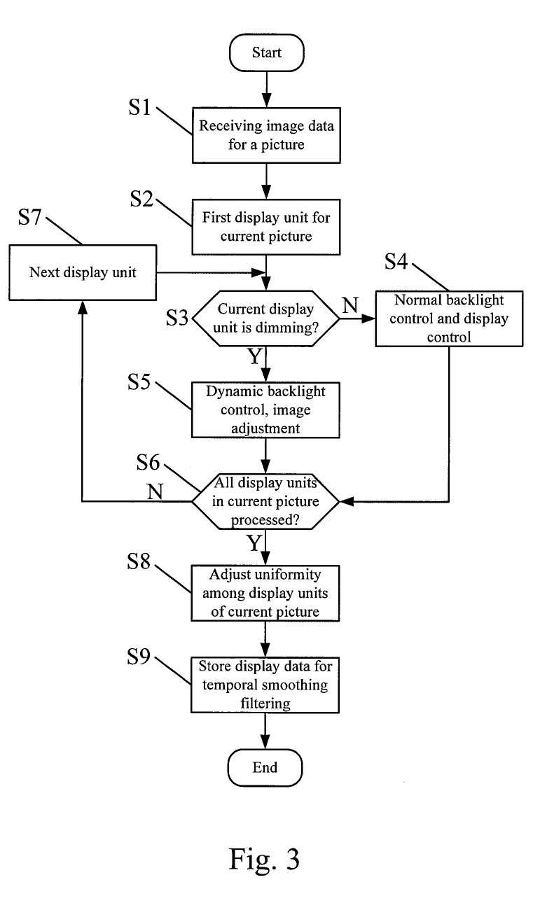

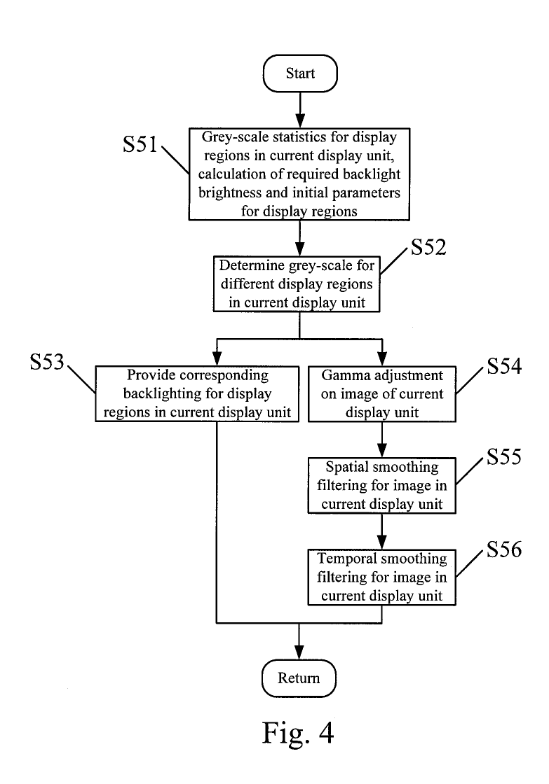

FIG. 3 is a flow chart illustrating the control process performed by the control device 20 of the LCD wall when displaying a picture according to the embodiment of the invention, and FIG. 4 is a flow chart showing the process performed on local dim units of the LCD wall during the processing step S5 in FIG. 3.

As shown in FIG. 3, at SI, the control device 20 receives image data from the signal input device 10. Specifically, the data from the signal input device 10 are input to the detection unit 211 in the control device 20. The image data may comprise a plurality of image frames for the respective display units in a picture, which may be input in parallel or in series.

At S2, a first display unit is set as the current display unit, which will be subject to the processes of following S3-S5.

At S3, determination is made on whether the current display unit is a dim unit. The detection unit 211 in the control device 20 makes a bright/dim determination on the current image frame contained in the image data of a picture to determine whether the display unit corresponding to the current image frame is a bright unit or a dim unit. In the embodiment, the bright/dim determination of an image frame on brightness of the display unit is made by calculation of statistical distribution of energy based on a grey-scale histogram of the image frame. In the calculation of statistical distribution, a ratio threshold M and a grey-scale threshold N are previously set, and may be set by a user depending on different usages. A pixel is referred to as a “dim pixel” if it has a grey-scale value lower than the grey-scale threshold N, otherwise it is referred to as a “bright pixel”. If the ratio of the dim pixels in an image frame is higher than or equal to the ratio threshold M, the display unit corresponding to the image frame is determined to be a dim unit; otherwise it is determined to be a bright unit. For example, if the grey-scale values of the pixels range from 0 to 256, then the grey-scale threshold N for determination may be 128, 64, 30, 10, 5, 2, or the like, and the ratio threshold M may be 50%, 75%, 90%, 95%, 98% or the like. However, the calculation of statistical distribution of energy based on the grey-scale histogram is only an illustrative embodiment, and other techniques known in the art may also be used for the bright/dim determination on the display unit. The result of determination of the detection unit 211 is transmitted to the uniformity adjusting unit 212 and the backlight controller 21. If the display unit corresponding to the inputted image frame is determined to be a bright unit in S3, the process moves on to S4; and if the display unit corresponding to the inputted image frame is determined to be a dim unit in S3, then the process moves on to S5.

At S4, normal backlight and display control is performed on the current display unit that has been determined to be a bright unit. For example, the backlights in the display array 30 normally illuminate, and the display controller 22 in the control device 20 does not further adjust the image of the current display unit; rather, the corresponding display unit in the display panel 31 normally display the image. After S4, the process moves on to S6.

At S5, dynamic backlight control is performed on the current display unit that has been determined to be a dim unit, and the image of the display unit is adjusted, especially in grey-scales. The process of S5 will be described in detail with reference to FIG. 4 below.

At S51 (FIG. 4), the grey-scale calculation is made on the display regions in the current display unit, and required backlight brightness and initial parameters of the respective display regions are calculated. Specifically, after the current display unit is determined to be a dim unit (in S3), it is possible to, using the result of the calculation of statistical distribution of energy based on the grey-scale histogram in S3 by the detection unit 211, find out the grey-scale maximum of each display region. With the grey-scale maximum and an effective utilization ratio of light which may be determined previously by experiments or calculation, the required backlight brightness may be calculated, and the initial dim parameters for the respective display regions may be set. After S51, the process moves on to S52.

At step S52, the respective grey-scale values for different display regions are determined in the current display unit that has been determined to be a dim unit, and the result of determination is supplied to the backlight controller 21. After S52, the process moves on to S53 and S54.

At S53, based on the grey-scale values of the respective display regions supplied by the display controller 22, the backlight controller 21 controls the backlights corresponding to the current display unit in the backlight device 32 of the display array 30 to provide corresponding backlighting for different display regions in the current display unit that have different initial dim parameters. Such control may be made using various methods. For example, a pulse width modulation (PWM) technique may be employed to output different pulse signals to the backlights corresponding to different display regions, and analog continuous dim may be employed also.

At S54, the Gamma adjusting unit 221 adjusts the Gamma parameters of the image frame of the current display unit by reducing the grey-scale values of the pixels in the image frame of the current display unit and then increasing the grey-scale values of the bright pixels corresponding to the dim region. After S53, the backlight for a local dim region will be reduced, and thus the grey-scale values of the bright pixels in the local dim region will also be reduced. One pixel in an image frame will be taken as an example. If a bright pixel in the dim region has a grey-scale value of 240 when the brightness of the backlight is 255, then the grey-scale value finally outputted for this bright pixel will be lower than 240 when the brightness of the backlight corresponding to the region is reduced to 240, and hence the contrast ratio will decrease. In order to compensate for decrease of the contrast ratio, the grey-scale value for the bright pixel may be increased. For example, if the grey-scale value for the pixel is increased from 240 to 250, the grey-scale value finally outputted for the pixel may approach 240, substantially equal to the value when the brightness of the backlight is 255. Increase of the grey-scale values of the bright pixels may be accomplished by stretch of the grey-scale histogram of the image. After S54, the process moves on to S55.

At S55, the spatial filter unit 222 performs spatial smoothing filtering on the image in the current display unit. In S53, since different backlight regions corresponding to different display regions in the display unit may have different brightness, there may be a lack of uniformity in grey-scale among the respective display regions in the display unit. The spatial smoothing filtering may eliminate or at least mitigate the non-uniformity in grey-scale so that the display quality for image may be improved. After S55, the process moves on to S56.

At S56, temporal smoothing filtering is made for the image displayed in the current display unit relative to the images previously displayed in the same display unit. As described above, the memory unit 230 stores the data in association with the image frames previously displayed in the respective display units. The temporal filter unit 223 performs the temporal smoothing filtering by reading the data for the current display unit stored in the memory unit 230, and comparing the data with the image frame to be displayed. The operation in S56 can eliminate flicker induced by excessive differences between the pixel values of successive image frames in a sequence of images of the same display unit. After the operations of S53 and S56, the S5 shown in FIG. 3 ends and the process moves on to S6.

At S6, the control device 20 determines whether the current display unit is the last one in the picture, that is, whether all the display units in the current picture have been processed. If the determination of S6 obtains a negative result (that is, there is still a display unit that has not been processed in the current picture), the process moves on to S7 to set the next display unit as the current display unit and then the operations in S3-S6 are repeated. If the determination of S6 obtains a positive result (that is, all the display units in the picture have been processed), the process moves on to S8.

At S8, the uniformity adjusting unit 212 performs spatial smoothing filtering among the respective display units of the picture to improve the uniformity, and hence the non-uniformity of the whole picture of the display wall, which is induced by excessive grey-scale difference among the content displayed in the respective display units, is avoided. After S8, the process moves on to S9.

At S9, the data in association with the image frames of the respective display units of the current picture are stored in the memory unit 230, and will be used for the temporal smoothing filtering of S56 when other pictures are displayed subsequently.

After the above process, the bright units, as well as the dim units that have been subject to the spatial and temporal filtering processes, in the picture are synthetically outputted to obtain the desired output picture. The image sequences that have been subject to the above adjusting processes are transmitted to the display panel 31 in the display array 30, and the backlights in the display array 30 corresponding to the dim units have also been controlled in step S53. As a result, the image signal displayed by the display array 30 can have high contrast ratio and good uniformity. In addition, since dynamic backlight control is available in the LCD wall 1, it is not necessary to provide fixed backlighting for each LCD display units in the display panel, and therefore it is possible to save energy.

Although the invention has been described in detail by using the specific embodiments with reference to the drawings, the description is merely illustrative. The invention may take other modified or alternative forms without departing from the spirit thereof The scope of the invention is defined not by the specific embodiments described above, but by the appended claims.

What is claimed is:

1. An LCD wall comprising a display array and a control device, wherein
the display array comprises a display panel and a backlight device,
the control device comprises:
a backlight controller configured to control the backlight device in the display array, and
display controller configured to receive image data and control the display of the image data on the display panel,
wherein the display controller is further configured to perform adjustment grey-scale on the image data corresponding to a backlight brightness of the backlight device.

2. The LCD wall according to claim 1, wherein the display controller comprises:
a detection unit for receiving the image data and performing a bright/dim determination on the display units contained in the display panel based on image frames contained in the image data to determine whether the display unit corresponding to each of the image frames is a bright unit or a dim unit;
a Gamma adjusting unit for adjusting a Gamma parameter of the image frame in each display unit that has been determined to be a dim unit;
a spatial filter unit for performing a spatial smoothing filtering on the image frame in each display unit that has been determined to be a dim unit;
a temporal filer unit for performing a temporal smoothing filtering on the sequentially displayed image frames in each display unit that has been determined to be a dim unit;
a uniformity adjusting unit for performing a spatial smoothing filtering among the display units; and
a memory unit for storing the data in association with the image frames that have been displayed for the temporal smoothing filtering.

3. The LCD wall according to claim 2, wherein the Gamma adjusting unit is configured to decrease grey-scale values of dim pixels in the image frame while maintain grey-scale values of bright pixels substantially unchanged, the dim pixel being a pixel having a grey-scale value lower than a grey-scale threshold, the bright pixel being a pixel having a grey-scale value not lower than the grey-scale threshold.

4. The LCD wall according to claim 2, wherein the detection unit is configured to perform the bright/dim determination by calculation of statistical distribution of energy based on a grey-scale histogram of the image frame.

5. The LCD wall according to claim 4, wherein the display unit corresponding to the image frame is determined to be a dim unit if a ratio of the pixels having a grey-scale value lower than a grey-scale threshold among the pixels in the image frame is higher or equal to a ratio threshold, and is determined to be a bright unit if a ratio of the pixels having a grey-scale value lower than the grey-scale threshold among the pixels in the image frame is lower than the ratio threshold.

6. The LCD wall according to claim 1, wherein
the display panel comprises a plurality of display units each of which comprises a plurality of display regions;
the backlight device comprises a plurality of backlight regions provided correspondingly to the display regions in a one-to-one correspondence; and
the backlight regions of the backlight device are independently controlled by the backlight controller so as to provide backlighting for the respective display regions independently.

7. The LCD wall according to claim 6, wherein the backlight controller is configured to control the backlight regions of the backlight device by using pulse width modulation.

8. The LCD wall according to claim 6, wherein the backlight controller is configured to control the backlight regions of the backlight device by using analog continuous dimming.

9. The LCD wall according to claim 1, wherein the control device comprises a signal input device integrated therein and used to generate the image data.

10. A method for controlling an LCD wall comprising a display array and a control device, the display array comprising a display panel and a backlight device, the method comprising:
controlling the backlight device in the display array; and
receiving image data and controlling the display of the image data on the display panel,
wherein the controlling the display of the image data on the display panel comprises adjusting grey-scale on the image data corresponding to a backlight brightness of the backlight device.

11. The method according to claim 10, wherein the adjusting grey-scale on the image data comprises:
performing a bright/dim determination on the display units contained in the display panel based on the image frames contained in the image data;
adjusting a Gamma parameter of the image frame;
performing a spatial smoothing filtering on the image of each display unit;
performing a temporal smoothing filtering on the sequentially displayed images of each display unit; and
performing a spatial smoothing filtering among the display units.

12. The method according to claim 11, wherein the adjusting the Gamma parameter of the image frame comprises: decreasing grey-scale values of dim pixels in the image frame while maintaining grey-scale values of bright pixels substantially unchanged, the dim pixel being a pixel having a grey-scale value lower than a grey-scale threshold, the bright pixel being a pixel having a grey-scale value not lower than the grey-scale threshold.

13. The method according to claim 11, wherein the bright/dim determination is made by calculation of statistical distribution of energy based on a grey-scale histogram of the image frame.

14. The method according to claim 13, wherein the display unit corresponding to the image frame is determined to be a dim unit if a ratio of the pixels having a grey-scale value lower than a grey-scale threshold among the pixels in the image frame is higher or equal to a ratio threshold, and is determined to be a bright unit if a ratio of the pixels having a grey-scale value lower than the grey-scale threshold among the pixels in the image frame is lower than the ratio threshold.

15. The method according to claim 10, wherein
the display array comprises a display panel and a backlight device,
the display panel comprises a plurality of display units each of which comprises a plurality of display regions;
the backlight device comprises a plurality of backlight regions provided correspondingly to the display regions in a one-to-one correspondence; and
the controlling the backlight device in the display array comprises controlling the backlight regions of the backlight device independently so as to provide backlighting for the respective display regions independently.

16. The method according to claim 15, wherein the control on the backlight device is made by using pulse width modulation.

17. The method according to claim 15, wherein the control on the backlight device is made by using analog continuous dimming.
